(19) United States
(12) Patent Application Publication
(10) Pub. No.: US 2005/0286050 A1
(43) Pub. Date: Dec. 29, 2005

(54) Real-time through lens image measurement system and method

(75) Inventors: Bausan Yuan, San Jose, CA (US); Martin Lee, San Jose, CA (US); Nobutaka Magome, Saitama (JP); Hidemi Kawai, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Nikon Corporation, Tokyo (JP)

(21) Appl. No.: 10/882,131

(22) Filed: Jun. 29, 2004

(51) Int. Cl. G01B 11/00

(52) U.S. Cl. 356/400

(57) ABSTRACT

Embodiments of the present invention are directed to an apparatus and a method for through lens measurement for a projection system. In one embodiment, an apparatus for through lens image measurement comprises a projection lens housing containing lens elements therein, and a reflective member having a center of curvature on a first plane. The reflective member is attached to the lens housing. An optical system includes a light source, a position detector, and one or more optical elements. The optical system is attached to the lens housing and configured to direct a light from the light source through the lens elements to the reflective member which reflects the light back through the lens elements and toward the position detector. The position detector is configured to detect any image shift at the first plane due to misalignment of the lens elements with respect to the lens housing.

### CROSS-REFERENCES TO RELATED APPLICATIONS

Not Applicable

### BACKGROUND OF THE INVENTION

The present invention relates generally to a system and a method for measuring stability of an image and, more particularly, to a real-time through lens image measurement for a projection system, which is measurement in a direction other than the system's optical axis (typically in the X and Y directions if the optical axis is in the Z direction).

An exposure apparatus is one type of precision assembly that is commonly used to transfer images from a reticle onto a semiconductor wafer during semiconductor processing. A typical exposure apparatus includes an illumination source, a reticle stage assembly that retains a reticle, an optical assembly, a wafer stage assembly that retains a semiconductor wafer, a measurement system, and a control system.

In one embodiment, the wafer stage assembly includes a wafer stage that retains the wafer, and a wafer mover assembly that precisely positions the wafer stage and the wafer. The reticle stage assembly includes a reticle stage that retains the reticle, and a reticle mover assembly that positions the reticle stage and the reticle. The control system independently directs current to the wafer mover assembly and the reticle mover assembly to generate one or more forces that cause the movement along a trajectory of the wafer stage and the reticle stage, respectively.

The size of the images and features within the images transferred onto the wafer from the reticle are extremely small. Accordingly, the precise positioning of the wafer and the reticle relative to the optical assembly is critical to the manufacture of high density, semiconductor wafers. In some embodiments, numerous identical integrated circuits are derived from each semiconductor wafer. Therefore, during this manufacturing process, the wafer stage and/or the reticle stage can be cyclically and repetitiously moved to emulate an intended trajectory. Each intended trajectory that is similar to a previous intended trajectory of one of the stages is also referred to herein as an “iteration” or a “cycle.”

Unfortunately, during the movement of the stages, a following error of the wafer stage and/or the reticle stage can occur. The following error is defined by the difference between the intended trajectory of the wafer stage and/or the reticle stage and an actual trajectory of the stage at a specified time. For example, the following error can occur due to a lack of complete rigidity in the components of the exposure apparatus, which can result in a slight time delay between current being directed to the mover assembly and subsequent movement of the stage.

Additionally, alignment errors can occur even if the stages are properly positioned relative to each other. For example, periodic vibration disturbances of various mechanical structures of the exposure apparatus may occur. More specifically, oscillation or resonance of the optical assembly housing and/or other supporting structures can inhibit relative alignment between the stages and the optical assembly housing. As a result of the following errors and/or the vibration disturbances which contribute to the synchronization error between the reticle and the wafer, precision in the manufacture of the semiconductor wafers can be compromised, potentially leading to production of a lesser quality semiconductor wafer. Attempts to decrease the synchronization error include the use of a feedback control loop. In these types of systems, during movement of one of the stages, the measurement system periodically provides information regarding the current position of the stage. This information is utilized by the control system to adjust the level of current to the mover assembly in an attempt to achieve the intended trajectory.

Interferometry systems such as heterodyne systems are typically used to measure the following errors of the reticle stage and the wafer stage. Such systems detect the difference of frequencies. Due to the chromatic aberration and the nature of the projection lens in the projection system, only light within a very limited wavelength range can pass through the projection lens. Consequently, the use of interferometry generally is not suitable for image measurement through the projection lens.

### BRIEF SUMMARY OF THE INVENTION

Embodiments of the present invention are directed to an apparatus and a method for through lens measurement for a projection system. The apparatus measures the stability of an image at the wafer's surface through the projection lens with high bandwidth while the projection lens is used for imaging the reticle onto the wafer. Critical sub-100 nm lithography and new materials in the lens render the present invention highly desirable. Instead of measuring frequency differences, the through lens measurement apparatus measures the position shift directly with intensity. The apparatus does so by employing actinic optics that are attached to the projection lens housing. Actinic optics are optics of or pertaining to the chemical property of ultraviolet radiation and x-rays that produces photochemical effects. A light source generates light having the same frequency as the light used for imaging the reticle onto the wafer. The light source and optical elements are mounted together mechanically and attached to the lens housing, so that any movement of the lens housing will not affect the position measurement. The light from the light source passes through the lens elements of the projection lens and is reflected by a reflective member attached to the opposite side of the lens housing. The reflected light is directed to a position detector which detects any position shift as a result of the image shift on the wafer image plane due to movement of the images' optical path through the lens elements, relative to the lens housing. Because the incoming and outgoing light beams use the same optical components of the optical system attached to the lens housing, the position spot at the position detector will not change, even if there is movement of the lens housing and the optical system attached thereto.

In accordance with an aspect of the present invention, an apparatus for through lens image measurement comprises a projection lens housing containing lens elements therein, and a reflective member having a center of curvature on a first plane. The reflective member is attached to the lens housing. An optical system includes a light source, a position detector, and one or more optical elements. The optical system is attached to the lens housing and configured to direct a light from the light source through the lens elements to the reflective member which reflects the light back through the lens elements and toward the position detector. The position detector is configured to detect any image shift at the first plane due to misalignment of the lens elements with respect to the lens housing.

In some embodiments, the position detector includes a reference location at which the light reflected from the reflective member through the lens elements is directed when the lens elements are aligned with respect to the lens housing. The light reflected from the reflective member through the lens elements is directed to a detected location on the position detector which is spaced from the reference location when the lens elements are misaligned with respect to the lens housing. The reflective member is selected from the group consisting of a convex mirror, a concave mirror, and a corner cube. The optical system may comprise actinic optical elements. The optical system comprises magnification objectives to magnify the light directed to the position detector. The magnification objectives provide 10× magnification for the light directed from the light source to the lens elements and for the light reflected back through the lens elements and toward the position detector. The position detector comprises a position sensor detector configured to detect a shift in position on a plane. The light source is configured to produce a source spot size with an intensity which, after passing through the one or more optical elements and the lens elements to the first plane, is equivalent to a light projecting an image from a second plane through the lens elements to the first plane, or, to have sufficient intensity at the detector as to allow the minimum desired motion detection at the design bandwidth.

In specific embodiments, the position detector includes a pin hole at a reference location, and the light from the light source is directed through the pin hole to pass through the lens elements toward the reflective member. The reference location is a location on the position detector at which the light reflected from the reflective member through the lens elements is directed when the lens elements are aligned with respect to the lens housing.

In accordance with another aspect of the invention, an apparatus for through lens image measurement comprises a projection lens housing containing lens elements therein, and a reflective member having a center of curvature on a first plane. The reflective member is attached to the lens housing. The apparatus includes a mechanism, attached to the lens housing, for directing a light through the lens elements to the reflective member which reflects the light back through the lens elements. A position detector is attached to the lens housing, and is positioned to receive the light reflected from the reflective member through the lens elements to measure any image shift at the first plane due to misalignment of the lens elements with respect to the lens housing.

In accordance with another aspect of this invention, a method for through lens image measurement comprises providing an optical system including a light source, a position detector, and one or more optical elements; attaching the optical system to a projection lens housing containing lens elements therein; and attaching a reflective member to the lens housing. The reflective member has a center of curvature on a first plane. The method further comprises directing a light from the light source through the lens elements to the reflective member which reflects the light back through the lens elements and toward the position detector; and detecting a location at which the reflected light strikes the position detector to determine any image shift at the first plane due to misalignment of the lens elements with respect to the lens housing.

In some embodiments, the method further comprises determining a reference location on the position detector at which the light reflected from the reflective member through the lens elements is directed when the lens elements are aligned with respect to the lens housing. Determining the reference location comprises, prior to attaching the reflective member to the lens housing, placing a planar reflective surface on the first plane to reflect the light from the light source through the lens elements toward the position detector; and adjusting the position detector to align the reference location with a location at which the light reflected from the planar reflective surface on the first plane strikes the position detector. Attaching the reflective member to the lens housing comprises positioning the reflective member to reflect the light from the light source through the lens elements toward the position detector to strike the position detector at the reference location when the lens elements are aligned with the lens housing.

In specific embodiments, the method further comprises calculating the image shift at the first plane based on a position shift between the detected location of the reflected light on the position detector and the reference location. The method may further comprise using the calculated image shift to correct a synchronization error between a mask and a substrate during projection of an image from the mask through the lens elements onto the substrate. The method may also include measuring movement of the reflective member, and using the measurement movement to correct the synchronization error. The method may further include measuring following errors of a mask stage for moving the mask and a substrate stage for moving the substrate, and using the following errors to correct the synchronization error. The synchronization error is corrected in real time. The light from the light source and a light used to project the image from the mask through the lens elements onto the substrate have substantially the same wavelength.

### BRIEF DESCRIPTION OF THE DRAWINGS

FIG. 1 is a simplified schematic illustration of an exposure apparatus having features of the present invention.

FIG. 2 is a simplified schematic illustration of a through lens image measurement apparatus according to an embodiment of the present invention.

FIG. 3 is a schematic view of the incident light path and return light path for the reflective member of FIG. 2 as a result of the image shift on the wafer image plane in the through lens image measurement apparatus of FIG. 2.

FIG. 4 is a schematic view of the position shift at the position detector plane as a result of the image shift on the wafer image plane in the through lens image measurement apparatus of FIG. 2.

FIG. 5 is a schematic view of another embodiment of the optical system in the through lens image measurement apparatus of FIG. 2.

### DETAILED DESCRIPTION OF THE INVENTION

Embodiments of the present invention are directed to real-time through lens image measurement for a projection exposure system used in photolithography. Exposure systems are known in the art, including those disclosed in U.S. Pat. Nos. 5,838,450; 6,233,042; 6,268,902; 6,249,336; 6,509,956; 6,359,688; 6,172,740; 6,235,438; and 6,522,386, the entire disclosures of which are incorporated herein by reference.

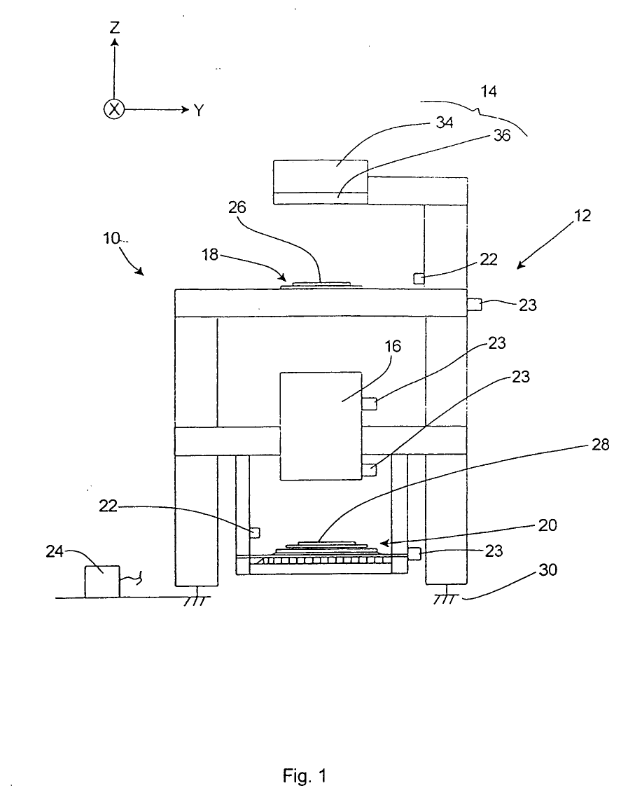

FIG. 1 is a simplified schematic illustration of a precision assembly, namely, an exposure apparatus 10. The exposure apparatus 10 includes an apparatus frame 12, an illumination system 14 (irradiation apparatus), an assembly 16 such as an optical assembly, a reticle stage assembly 18, a wafer stage assembly 20, a measurement system 22, one or more sensor 23, and a control system 24 having features of the present invention. The specific design of the components of the exposure apparatus 10 may be varied to suit the design requirements of the particular application.

As provided herein, the control system 24 utilizes a position compensation system or module that improves the accuracy in the control and relative positioning of at least one of the stage assemblies 18, 20. An orientation system used herein includes an X axis, a Y axis which is orthogonal to the X axis, and a Z axis which is orthogonal to the X and Y axes. The X, Y, and Z axes are also referred to as first, second, and third axes. The exposure apparatus 10 is particularly useful as a lithographic device that transfers a pattern of an integrated circuit from a reticle 26 onto a semiconductor wafer 28. The exposure apparatus 10 is mounted to a mounting base 30, such as the ground, a base, a floor, or some other supporting structure.

There are different types of lithographic devices. For example, the exposure apparatus 10 may be used as a scanning type photolithography system that exposes the pattern from the reticle 26 onto the wafer 28 with the reticle 26 and the wafer 28 moving synchronously. In a scanning type lithographic device, the reticle 26 is moved perpendicularly to an optical axis of the assembly 16 by the reticle stage assembly 18 and the wafer 28 is moved perpendicularly to the optical axis of the assembly 16 by the wafer stage assembly 20. Scanning of the reticle 26 and the wafer 28 occurs while the reticle 26 and the wafer 28 are moving synchronously.

The apparatus frame 12 is rigid and supports the components of the exposure apparatus 10. As seen in FIG. 1, the apparatus frame 12 supports the assembly 16 and the illumination system 14 above the mounting base 30. The illumination system 14 includes an illumination source 34 and an illumination optical assembly 36. The illumination source 34 emits a beam (irradiation) of light energy. The illumination optical assembly 36 guides the beam of light energy from the illumination source 34 to the assembly 16. The beam illuminates selectively different portions of the reticle 26 and exposes the wafer 28. The assembly 16 is typically an optical assembly that projects and/or focuses the light passing through the reticle 26 to the wafer 28. Depending upon the design of the exposure apparatus 10, the assembly 16 can magnify or reduce the image illuminated on the reticle 26. The assembly 16 need not be limited to a reduction system, but may be a 1× or a magnification system.

The reticle stage assembly 18 holds and positions the reticle 26 relative to the assembly 16 and the wafer 28. Somewhat similarly, the wafer stage assembly 20 holds and positions the wafer 28 with respect to the projected image of the illuminated portions of the reticle 26. Movement of the stages generates reaction forces that can affect performance of the photolithography system. Typically, numerous integrated circuits are derived from a single wafer 28. Therefore, the scanning process may involve a substantial number of repetitive, identical, or substantially similar movements of portions of the reticle stage assembly 18 and/or the wafer stage assembly 20. Each such repetitive movement is also referred to herein as an iteration, iterative movement, or iterative cycle.

The measurement system 22 monitors movement of the reticle 26 and the wafer 28 relative to the assembly 16 or some other reference. With this information, the control system 24 can control the reticle stage assembly 18 to precisely position the reticle 26 and the wafer stage assembly 20 to precisely position the wafer 28 relative to the assembly 16. For example, the measurement system 22 may utilize multiple laser interferometers, encoders, and/or other measuring devices. Additionally, one or more sensors 23 can monitor and/or receive information regarding one or more components of the exposure apparatus 10. Information from the sensors 23 can be provided to the control system 24 for processing. The control system 24 also receives information from the measurement system and other systems, and controls the stage mover assemblies 18, 20 to precisely and synchronously position the reticle 26 and the wafer 28 relative to the assembly 16 or some other reference. The control system 24 includes one or more processors and circuits for performing the functions described herein.

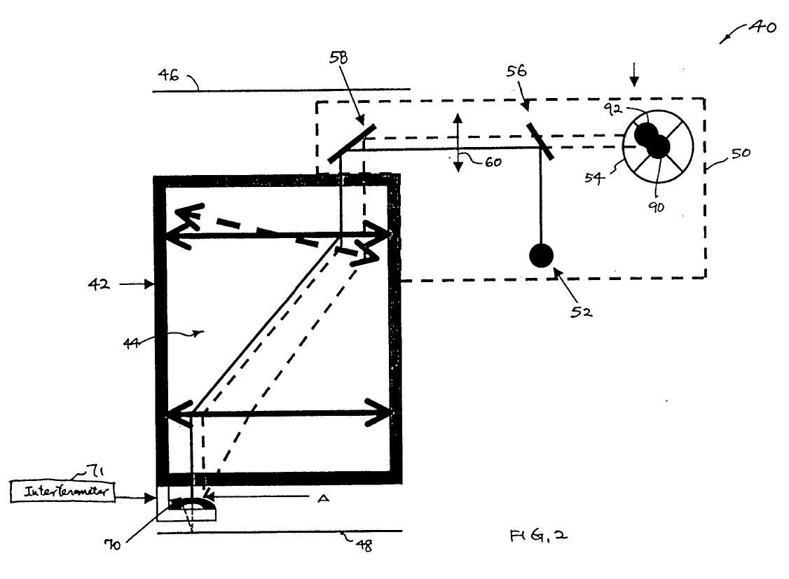

FIG. 2 is a simplified schematic illustration of a through lens image measurement apparatus 40 for a system such as the projection system 10 of FIG. 1 according to an embodiment of the present invention. The apparatus 40 employs actinic optics that are attached to the top and the bottom of a projection lens barrel or housing 42 which contains lens elements 44. The lens housing 42 represents the optical assembly 16 in the projection system 10 of FIG. 1. The reticle stage assembly 18 of FIG. 1 supports and moves the reticle or mask on the reticle object plane 46, while the wafer stage assembly 20 of FIG. 1 supports and moves the wafer or substrate on the wafer image plane 48. The lens elements 44 used for imaging the reticle to the wafer are also used to measure the stability of an image through the lens with high bandwidth in the through lens image measurement apparatus 40 of FIG. 2. The apparatus 40 measures any relative motion between the lens elements 44 and the lens housing 42 in real time to determine the image quality. The measurement can then be used to correct the synchronization error due to any instability of the lens elements 44.

An optical system 50 attached to the top of the lens housing 42 includes a light source 52, a position detector 54, and one or more optical elements for directing light to and from the lens elements 44. As shown in FIG. 2, the optical elements include a beam splitter 56, a planar mirror 58, and magnification objectives 60. The beam splitter 56 is oriented to reflect the light generated by the light source 52 to the planar mirror 58 which directs the light to the lens elements 44. The light which returns from the lens elements 44 is reflected by the planar mirror 58 through the beam splitter 56 to the position detector 54. The position detector 54 may be a position sensor detector (PSD) such as a quad sensor which detects a shift in position of the return light on a plane (X, Y). The magnification objectives 60 are disposed between the beam splitter 56 and the planar mirror 58, and magnify the light passing therethrough. The magnification provides better sensitivity in sensing the position shift and hence improves the accuracy of the detection of the position shift. In an exemplary embodiment, the magnification objectives 60 produce 10× magnification. The light source 52 produces a source spot size with the intensity which is equivalent to light projected from the reticle object plane 46 with the magnification provided by the magnification objectives 60.

The return light is reflected by a reflective member 70 attached to the bottom of the lens housing 42. The reflective member 70 has a center of curvature on the wafer image plane 48. In the exemplary embodiment shown, the reflective member 70 is a convex mirror which may be a spherical mirror. In other embodiments, the reflective member 70 may be a concave mirror, corner cube, or the like. The optical system 50 is configured such that the position detector 54 is located at the conjugate plane for the wafer image plane 48. The position detector 54 is configured to detect any image shift at the wafer image plane 48 due to misalignment of the lens elements 44 with respect to the lens housing 42. As shown in FIG. 2, the position detector 54 includes a reference location 90 at which the light reflected from the reflective member 70 through the lens elements 44 is directed when the lens elements 44 are aligned with respect to the lens housing 42. The light generated by the light source 52 is reflected by the beam splitter 56, magnified by the magnification objectives 60, and reflected by the planar mirror 58 through the lens elements 44 to the reflective member 70. The reflective member 70 reflects the light through the lens elements 44 along a return path which will be the same as the incident path if the lens elements 44 are aligned with the lens housing 42. The reflected light will then strike the position detector at the reference location 90, as shown by the solid line in FIG. 2. A misalignment of the lens elements 44 will cause the return path of the light to shift from the incident path. The light reflected from the reflective member 70 through the lens elements is directed to a detected location 92 on the position detector 54 which is spaced from the reference location 90 when the lens elements 44 are misaligned with respect to the lens housing 42. This is illustrated by the light path shown in broken lines in FIG. 2.

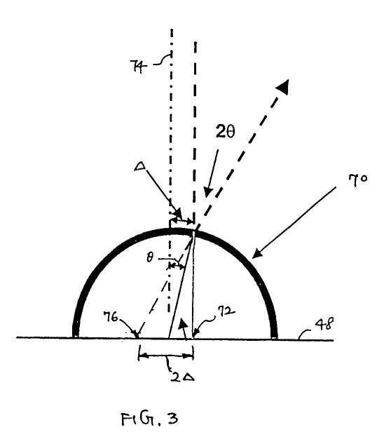

FIG. 3 shows an example of correlating the image shift at the wafer image plane 48 with the position shift of the return light detected by the position detector 54 located at the conjugate plane for the wafer image plane 48. The convex mirror 70 has a radius of curvature r, which is 3 mm in a specific example. The image shift on the wafer image plane 48 is A, which projects to location 72 on the wafer image plane 48. The incident light strikes the reflective member 70 on the reflective surface located at an angle θ with respect to the centerline 74. The reflected light makes an angle of 2θ with respect to the incident light, which represents a virtual image shift at location 76 on the wafer image plane 48, which is at a distance Δ from the centerline 74 and 2rΔ/r=2Δ from the location 72. The position shift as detected at the position detector at the conjugate plane from the centerline or reference location 90 is 2Δ multiplied by the inverse of the reduction ratio of the lens elements 44 and multiplied by the magnification factor of the magnification objectives 60. In one example, the image shift A is 1 nm, the inverse of the reduction ratio of the lens elements 44 is 4, and the magnification factor of the magnification objectives 60 is 10, so that the position shift on the position detector is 2 nm*4*10=80 nm.

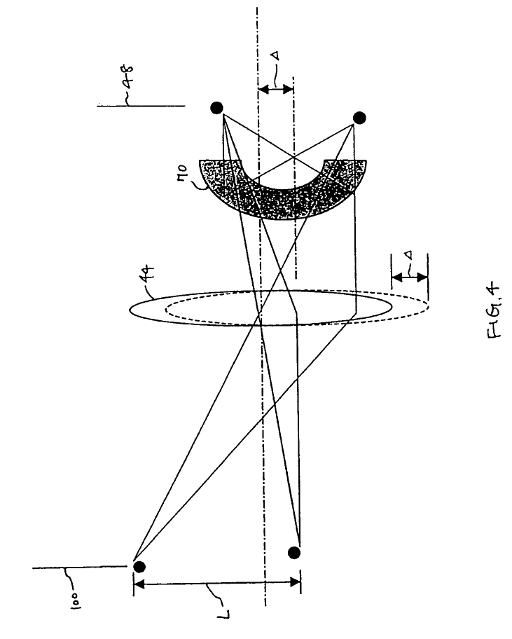

FIG. 4 shows a schematic view of the position shift L at the position detector plane 100 as a result of the image shift Δ on the wafer image plane 48. FIG. 4 is a simplified view for illustrative purposes without showing all the optical elements. One way to correlate the position shift L with the image shift Δ is to measure the image shift Δ on the wafer at the wafer image plane 48 and compare it with the position shift L detected by the position detector 54 at the detection plane 100. The measurement and comparison will provide a calibration factor or correlation factor that can be used to determine the image shift Δ at the wafer image plane 48 based on the position shift L detected by the position detector 54 at the detection plane 100.

During initial setup of the apparatus 40, the position detector 54 is placed such that the reference location 90 is aligned with the return light when the lens elements 44 are aligned with the lens housing 42 with no instability or relative movement. One way to do so is to place a planar reflective surface such as a wafer on the wafer place 48, prior to attaching the reflective member 70 to the lens housing 42, to reflect the light from the light source 52 through the lens elements 44 toward the position detector 54. The position detector 54 is adjusted such that the light strikes the position detector 54 at the reference location 90. Once the position of the position detector 54 is fixed, the reflective member 70 is mounted to the lens housing 42. The position of the reflective member 70 is selected such that the light reflected by the reflective member 70 through the lens elements 44 toward the position detector 54 strikes the position detector 54 at the reference location 90 when the lens elements 44 are aligned with the lens housing 42.

In operation, the light generated by the light source 52 is directed by the optical elements in the optical system 50 through the lens elements 44 to the reflective member 70 which reflects the light back through the lens elements 44 toward the position detector 54 at the detected location 92. The image shift A at the wafer image plane 48 is calculated based on the position shift between the detected location 92 of the reflected light on the position detector 54 and the reference location 90. The image shift Δ can be used to correct the synchronization error between the reticle and the wafer attributed to the instability of the lens elements 44 during projection of an image from the reticle through the lens elements 44 onto the wafer. The light from the light source 52 and the light used to project the image from the reticle through the lens elements 44 to the wafer have substantially the same wavelength, for instance, in the DUV range. In addition, the following error of the reticle stage and the following error of the wafer stage may be taken into account in correcting the synchronization error. The following errors may be measured using interferometers or the like. Moreover, any movement of the lens housing 42 may be measured and used to correct the synchronization error. Because the reflective member 70 that is attached to the lens housing 42 is the most sensitive component, an interferometer 71 may be used to monitor movement of the reflective member 70 and the measurement used to correct the synchronization error attributed to movement of the lens housing 42. Advantageously, these error measurements, including the through lens image measurement, may be performed in real time, and the correction of the synchronization error based on the measurements may also be done in real time.

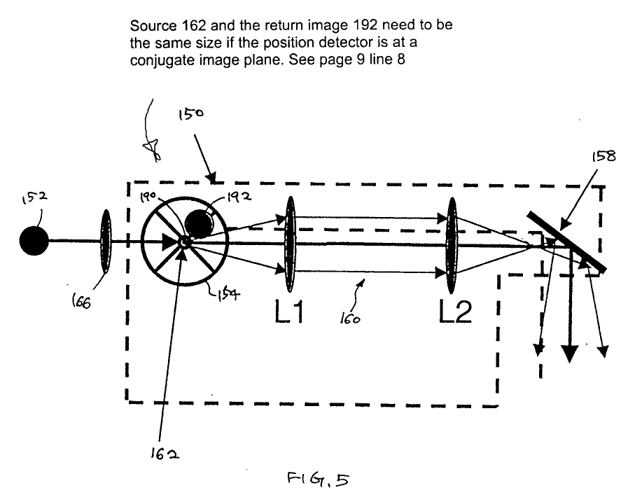

FIG. 5 shows another embodiment of the optical system 150, which includes a light source 152, a position detector 154, and one or more optical elements for directing light to and from the lens elements 44. The optical elements include a planar mirror 158 and magnification objectives 160 including magnification lenses L1 and L2, which are disposed between the position detector 154 and the planar mirror 158. In an exemplary embodiment, the magnification objectives 160 produce 10× magnification. The position detector 154 includes a pin hole 162 at the reference location 190. A lens 166 is placed between the light source 152 and the position detector 154. The light generated by the light source 152 is directed through the pin hole 162 of the position detector 154, and passes through the magnification objectives 160 to the planar mirror 158 which reflects the light toward the lens elements 44. The light reflected by the reflective member 70 back through the lens elements 44 is reflected by the planar mirror 158 through the magnification objectives 160, and strikes the position detector 154 at the detected location 192. The position shift between the reference location 190 and the detected location 192 can be used to determine the image shift on the wafer image plane 48. The light source 152 produces a light with the intensity which is equivalent to light projected from the reticle object plane 46 with the magnification provided by the magnification objectives 160. The use of the pin hole 162 advantageously generates a light beam with perfect spherical wavefront. The size of the pin hole 162 is selected based on the numerical aperture of the magnification lens L1. Furthermore, the optical system 150 provides fully common path optics.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

1. An apparatus for through lens image measurement, the apparatus comprising:
a projection lens housing containing lens elements therein;
a reflective member having a center of curvature on a first plane, the reflective member being attached to the lens housing; and
an optical system including a light source, a position detector, and one or more optical elements, the optical system being attached to the lens housing and configured to direct a light from the light source through the lens elements to the reflective member which reflects the light back through the lens elements and toward the position detector;
wherein the position detector is configured to detect any image shift at the first plane due to misalignment of the lens elements with respect to the lens housing.

2. The apparatus of claim 1 wherein the position detector includes a reference location at which the light reflected from the reflective member through the lens elements is directed when the lens elements are aligned with respect to the lens housing, and wherein the light reflected from the reflective member through the lens elements is directed to a detected location on the position detector which is spaced from the reference location when the lens elements are misaligned with respect to the lens housing.

3. The apparatus of claim 1 wherein the reflective member is selected from the group consisting of a convex mirror, a concave mirror, and a corner cube.

4. The apparatus of claim 1 wherein the optical system comprises actinic optical elements.

5. The apparatus of claim 1 wherein the optical system comprises a beam splitter disposed in a path of the light from the light source and in a return path of the light reflected from the reflective member toward the position detector.

6. The apparatus of claim 1 wherein the optical system comprises magnification objectives to produce an image conjugate of the reticle image plane at the position detector.

7. The apparatus of claim 6 wherein the magnification objectives provide 10× magnification for the light directed from the light source to the lens elements and for the light reflected back through the lens elements and toward the position detector.

8. The apparatus of claim 1 wherein the position detector comprises a position sensor detector configured to detect a shift in position on a plane.

9. The apparatus of claim 1 wherein the position detector includes a pin hole at a reference location, wherein the light from the light source is directed through the pin hole to pass through the lens elements toward the reflective member, and wherein the reference location is a location on the position detector at which the light reflected from the reflective member through the lens elements is directed when the lens elements are aligned with respect to the lens housing.

10. The apparatus of claim 1 wherein the light source is configured to produce a source spot size with an intensity which, after passing through the one or more optical elements and the lens elements to the first plane, is equivalent to a light projecting an image from a second plane through the lens elements to the first plane.

11. An apparatus for through lens image measurement, the apparatus comprising:
a projection lens housing containing lens elements therein;
a reflective member having a center of curvature on a first plane, the reflective member being attached to the lens housing;
means, attached to the lens housing, for directing a light through the lens elements to the reflective member which reflects the light back through the lens elements; and
a position detector attached to the lens housing, the position detector being positioned to receive the light reflected from the reflective member through the lens elements to measure any image shift at the first plane due to misalignment of the lens elements with respect to the lens housing.

12. The apparatus of claim 11 wherein the position detector includes a reference location at which the light reflected from the reflective member through the lens elements is directed when the lens elements are aligned with respect to the lens housing, and wherein the light reflected from the reflective member through the lens elements is directed to a detected location on the position detector which is spaced from the reference location when the lens elements are misaligned with respect to the lens housing.

13. The apparatus of claim 11 wherein the means magnifies the image produced at the position detector.

14. The apparatus of claim 11 wherein the position detector comprises a position sensor detector configured to detect a shift in position of an image produced thereat.

15. The apparatus of claim 11 further comprising an interferometer configured to measure the position of the reflective member.

16. A method for through lens image measurement, the method comprising:
providing an optical system including a light source, a position detector, and one or more optical elements;
attaching the optical system to a projection lens housing containing lens elements therein;
attaching a reflective member to the lens housing, the reflective member having a center of curvature on a first plane;
directing a light from the light source through the lens elements to the reflective member which reflects the light back through the lens elements and toward the position detector; and
detecting a location at which the reflected light strikes the position detector to determine any image shift at the first plane due to misalignment of the lens elements with respect to the lens housing.

17. The method of claim 16 further comprising determining a reference location on the position detector at which the light reflected from the reflective member through the lens elements is directed when the lens elements are aligned with respect to the lens housing.

18. The method of claim 17,
wherein determining the reference location comprises, prior to attaching the reflective member to the lens housing, placing a planar reflective surface on the first plane to reflect the light from the light source through the lens elements toward the position detector; and
adjusting the position detector to align the reference location with a location at which the light reflected from the planar reflective surface on the first plane strikes the position detector; and
wherein attaching the reflective member to the lens housing comprises positioning the reflective member to reflect the light from the light source through the lens elements toward the position detector to strike the position detector at the reference location when the lens elements are aligned with the lens housing.

19. The method of claim 17 further comprising calculating the image shift at the first plane based on a position shift between the detected location of the reflected light on the position detector and the reference location.

20. The method of claim 19 further comprising using the calculated image shift to correct a synchronization error between a mask and a substrate during projection of an image from the mask through the lens elements onto the substrate.

21. The method of claim 20 further comprising measuring movement of the reflective member, and using the measurement movement to correct the synchronization error.

22. The method of claim 21 further comprising measuring following errors of a mask stage for moving the mask and a substrate stage for moving the substrate, and using the following errors to correct the synchronization error.

23. The method of claim 20 wherein the synchronization error is corrected in real time.

24. The method of claim 20 wherein the light from the light source and a light used to project the image from the mask through the lens elements onto the substrate have substantially the same wavelength.

25. The method of claim 16 further comprising magnifying the light reflected through the lens elements to the position detector.

26. The method of claim 16 further comprising magnifying the light directed from the light source through the lens elements.

27. The method of claim 16 wherein the reflective member is selected from the group consisting of a convex mirror, a concave mirror, and a corner cube.

28. The method of claim 16 wherein the optical system comprises actinic optical elements.

29. The method of claim 16 wherein directing a light from the light source through the lens elements comprises directing the light to a beam splitter which reflects the light to the lens elements, and wherein the reflected light from the reflective member through the lens elements passes through the beam splitter to strike the position detector.

30. The method of claim 16 wherein directing a light from the light source through the lens elements comprises directing the light through a pin hole at a reference location of the position detector to pass through the lens elements toward the reflective member, and wherein the reference location is a location on the position detector at which the light reflected from the reflective member through the lens elements is directed when the lens elements are aligned with respect to the lens housing.
